(19) United States
(12) Patent Application Publication
(10) Pub. No.: US 2007/0132724 A1
(43) Pub. Date: Jun. 14, 2007

(54) INPUT DEVICE AND ELECTRONIC APPARATUS USING THE SAME

(75) Inventor: Tetsuo Muranaka, Fukushima-ken (JP)

Correspondence Address: BRINKS HOFER GILSON & LIONE, P.O. BOX 10395, CHICAGO, IL, 60610, US

(73) Assignee: ALPS ELECTRIC CO., LTD., Tokyo (JP)

(21) Appl. No.: 11/609,769

(22) Filed: Dec. 12, 2006

(30) Foreign Application Priority Data
Dec. 14, 2005 (JP) 2005-359798

(51) Int. Cl. G09G 5/00

(52) U.S. Cl. 345/156

(57) ABSTRACT

An input device having a substrate having a first region and a second region. The first region is configured to receive movement operations by an input mechanism, such as to control a pointer or cursor on a display. The second region has an input pad, such as a number pad, to generate absolute signals in response to contact by the input mechanism.

### RELATED APPLICATION

This application claims the benefit of Japanese Application 2005-359798, filed Dec. 14, 2005, which is hereby incorporated by reference herein.

### FIELD OF THE INVENTION

The present invention relates to input devices that detect changes in electrostatic capacitance in response to an input mechanism, such as a finger. More particularly, an input device having both relative and absolute positional input regions is disclosed.

### BACKGROUND

JP-A-2005-182837 discloses a pad-type input device that detects the variation of electrostatic capacitance. In the electrostatic-capacitance-detection-type input device, a plurality of X electrodes extending in parallel to the Y direction are provided on one surface of a substrate, such as a resin film, and a plurality of Y electrodes extending in the X direction are provided on the other surface thereof. In addition, detection electrodes serving as common electrodes are provided between adjacent X electrodes or adjacent Y electrodes.

In the input device, a voltage is applied to the X electrodes and the Y electrodes in the order and a detection output can be obtained from the detection electrodes. When a finger, which is a conductor, approaches an input device, electrostatic capacitance between the finger and corresponding detection electrode occurs in addition to electrostatic capacitance between the detection electrode and corresponding X electrode or Y electrode at a portion where the finger has approached, and as a result, the electrostatic capacitance is reduced. The signal change at this time is detected in the detection electrode.

When using an operation principle of the electrostatic-capacitance-detection-type input device, a portion operated by a finger may be detected as absolute coordinate data, that is, position data on X-Y coordinate. However, in the case when the input device is mounted in a personal computer (PC), driver software installed in the PC causes the absolute coordinate data to be converted to a relative coordinate output equal to an output of a mouse, that is, converted to a signal output indicating the movement of an operated portion and the direction of the movement and is then applied to an operation system (OS) of the PC.

Accordingly, in order to perform an operation of, for example, moving a pointer (indicating mark) on a screen by the use of the input device, an operation in a relative coordinate input mode may be performed in the same manner as an input operation using a mouse. However, in the case of performing an operation of writing characters on a screen, the relative coordinate output and an operation output of a button used together in the input device should be combined to write the characters on the screen because the relative coordinate output is a basis.

To perform an operation of moving a pointer and an operation of writing characters in the same input device, the operations need to be automatically switched according to application software, for example. That is, in corresponding driver software, it is necessary to determine whether to process an operation mode of the input device as a relative coordinate input mode for moving a pointer or to process the operation mode of the input device as an absolute coordinate input mode for writing the characters in which the relative coordinate output and the button operation output are combined and then switch between the operation modes. For this reason, it has been troublesome to perform an input operation by moving a pointer on a screen to a predetermined portion and then to immediately write characters.

### SUMMARY

The present invention is defined by the claims and nothing in this section should be taken as a limitation on those claims.

An input device is disclosed that has a substrate having a first region and a second region. In a preferred version, the first region is configured to receive movement operations by an input mechanism, such as to control a pointer or cursor on a display. The input mechanism may be a finger. The second region has an input pad, such as a number pad, to generate absolute signals in response to contact by the input mechanism. A processor generates a relative coordinate output based upon a signal received from the first region and an absolute coordinate output based upon a signal received from the second region.

The preferred embodiments will now be described with reference to the attached drawings.

### BRIEF DESCRIPTION OF THE DRAWINGS

FIG. 1 is an illustration of an electronic apparatus that incorporates a version of an input device of the present disclosure;

FIG. 2 is a cross-sectional view taken along the line II-II of FIG. 1;

FIG. 3 is a circuit diagram of a sensor control unit of the input device of FIG. 1;

FIG. 4 is a circuit diagram of the input device of FIG. 1;

FIG. 5 is a flow chart illustrating processing operations of a data processing unit provided in the input device of FIG. 1;

FIG. 6 is a front view of the electronic apparatus of FIG. 1 illustrating an operation example in a relative coordinate input mode; and

FIG. 7 is a front view of the electronic apparatus of FIG. 1 illustrating an operation example in an absolute and relative coordinate input mode.

### DETAILED DESCRIPTION OF THE PRESENTLY PREFERRED EMBODIMENTS

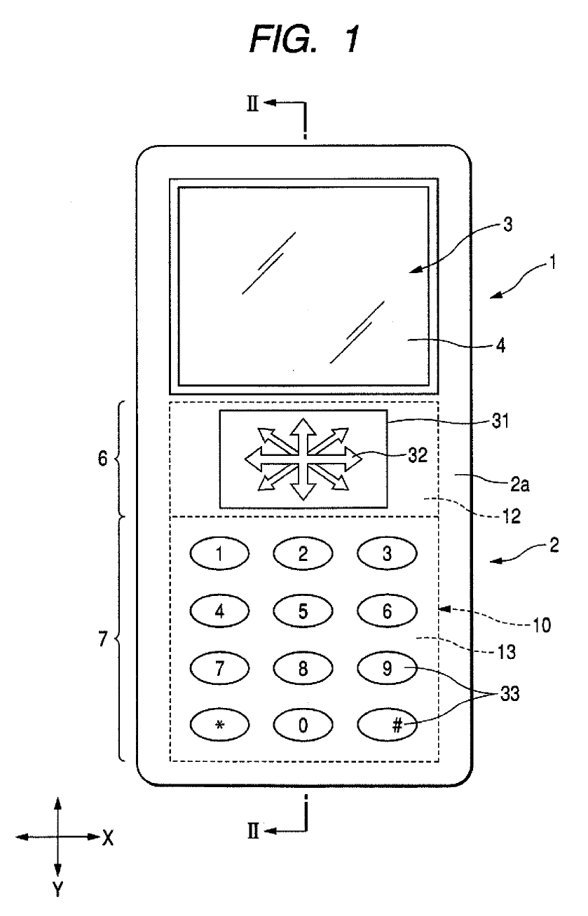

FIG. 1 is an illustration of an electronic apparatus 1 that incorporates a version of an input device having FIG. 1 is a block diagram schematically illustrating the configuration of a scroll control apparatus having an input device.

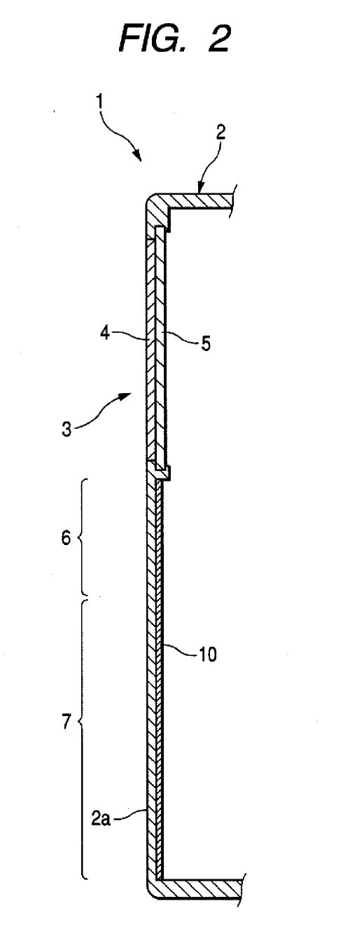

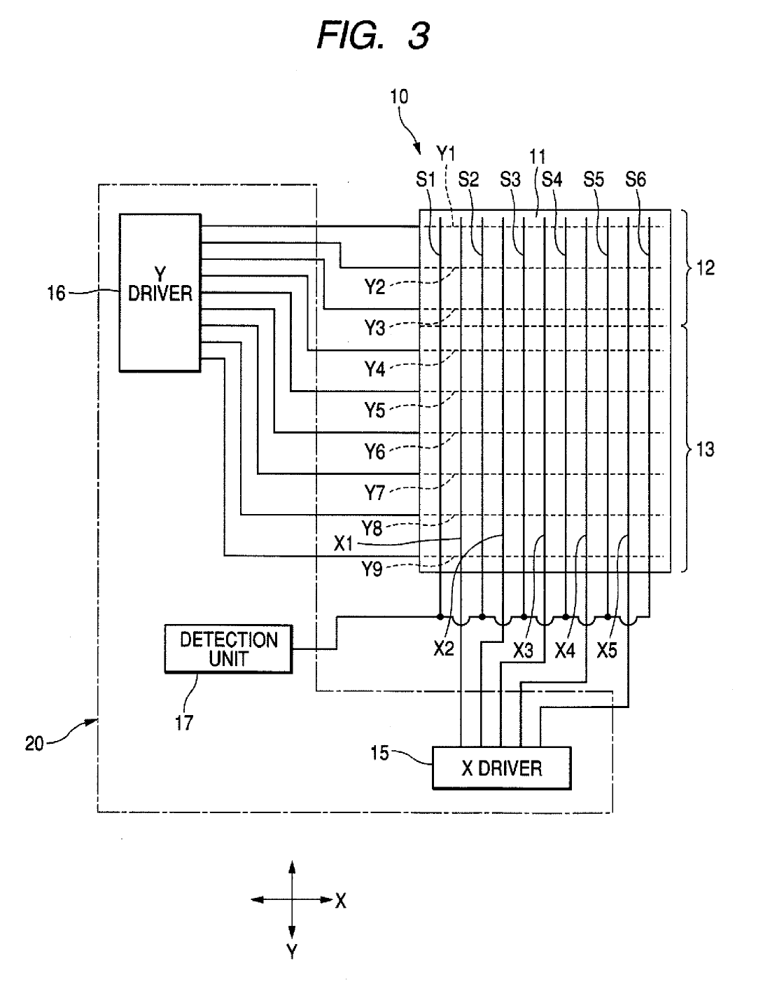

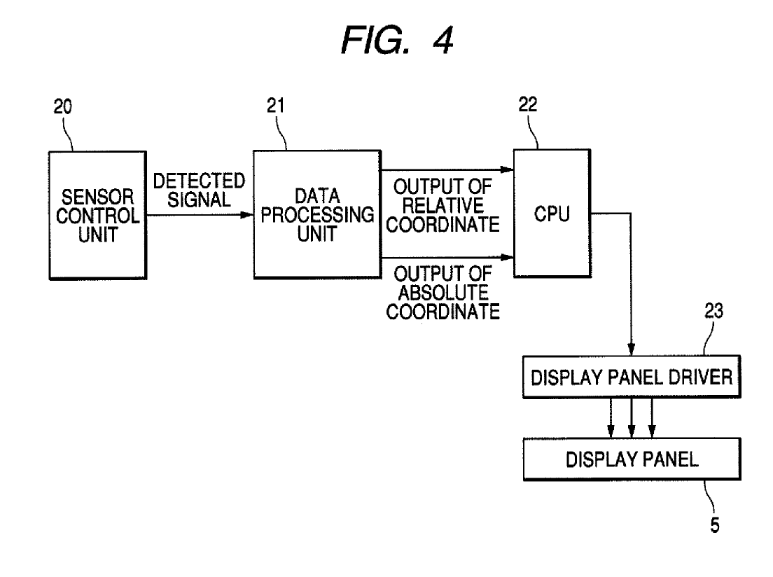

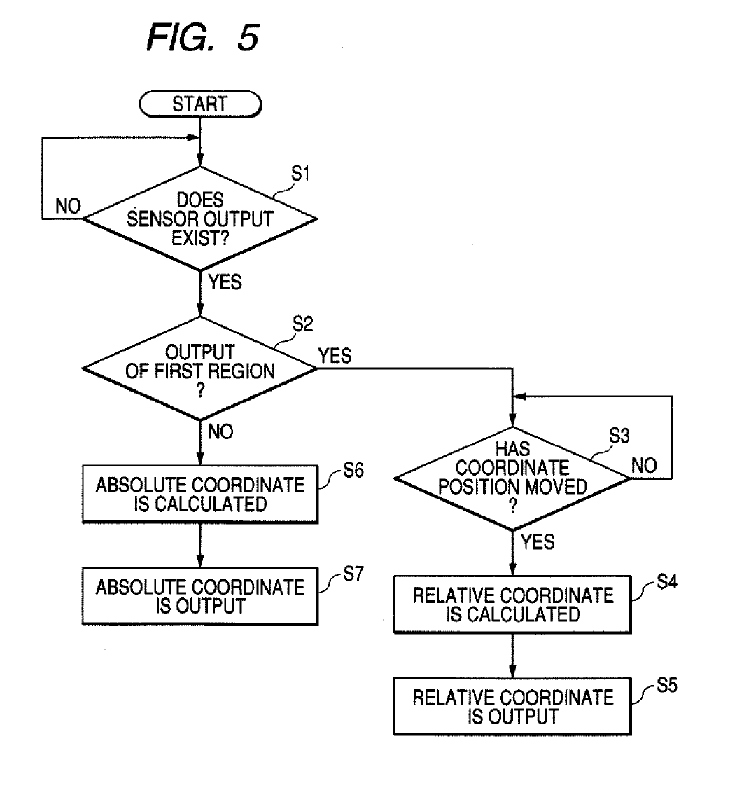

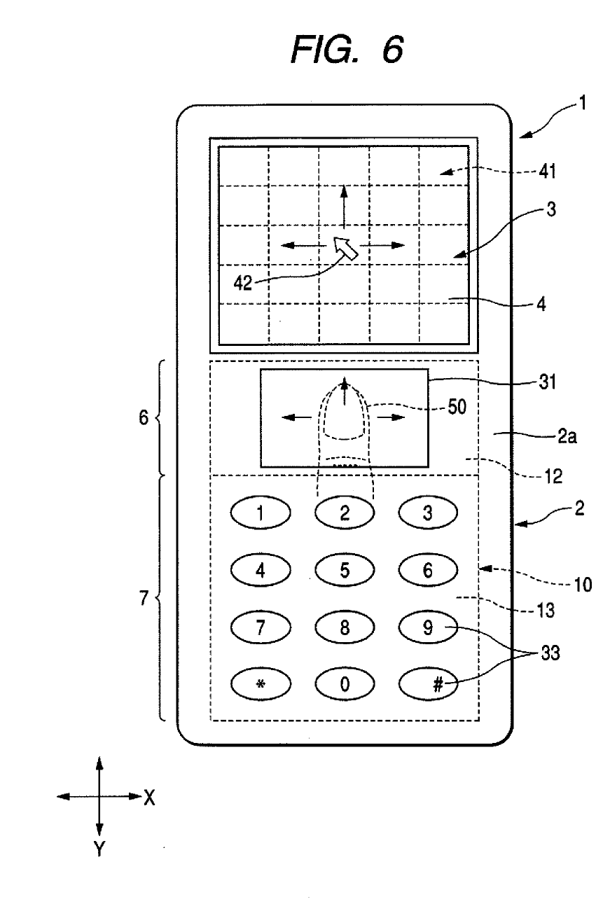

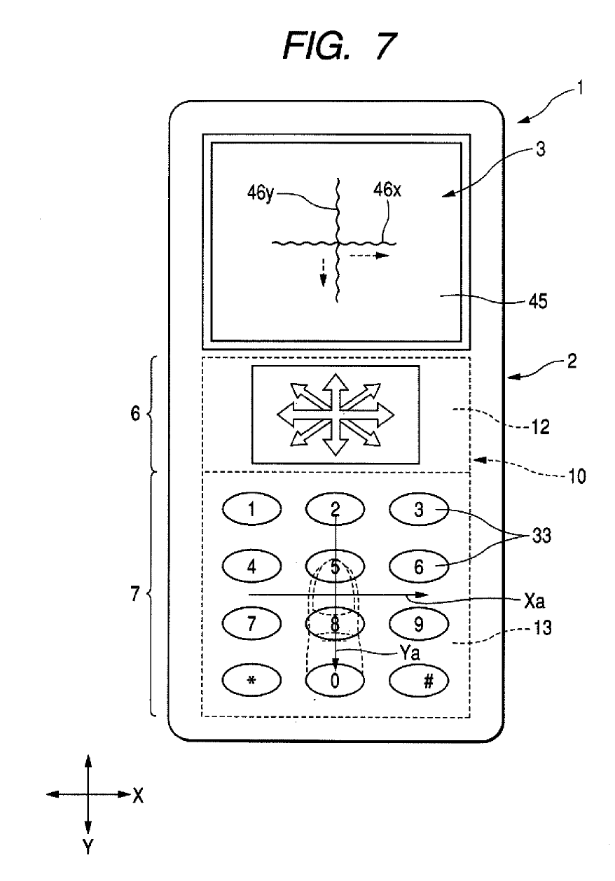

FIG. 1 is a front view illustrating an electronic apparatus according to an embodiment of the invention, FIG. 2 is a cross-sectional view illustrating a part of the electronic apparatus taken along the line II-II of FIG. 1, FIG. 3 is an explanatory view illustrating the configuration of an input device, FIG. 4 is a block circuit diagram illustrating the electronic apparatus, FIG. 5 is a flow chart illustrating processing operations of the input device, and FIGS. 6 and 7 are front views illustrating examples of an operation of the electronic apparatus.

In one version, the electronic apparatus 1 is small and portable. Examples include a mobile phone, a portable game device, a portable audio device having a hard disk unit or a flash memory therein, a portable and small personal compute, or the like.

The electronic apparatus 1 has a casing 2 that may be made of a synthetic resin. A circuit substrate and/or other components inside the casing 2 may form one or more of the devices described above. As shown in FIG. 2, a front surface 2a of the casing 2 is appropriately flat. An upper part of the front surface 2a in the longitudinal direction (Y direction) is a display region 3. In the display region 3, a transparent cover plate 4 is mounted on the casing 2 and a surface of the cover plate 4 is the same as the front surface 2a. The cover plate 4 is a transparent resin plate or a glass plate. In the display region 3, a display panel 5 is provided below the cover plate 4. By the display panel 5, a still image and a moving picture may be arbitrarily displayed in the display region 3. For example, the display panel 5 may be a liquid crystal display panel, a plasma display panel, or an LED display panel.

On the front surface 2a of the casing 2, an operation region is provided at a lower part of the display region 3 in the longitudinal direction. The operation region includes a first operation region 6 located below the display region 3, and a second operation region 7 located below the first operation region 6. In the present embodiment, the second operation region 7 is larger than the first operation region 6. However, the first operation region 6 may be larger than the second operation region 7.

A sensor 10, which is adhered and fixed to an inner surface of the casing 2, is provided at an inner side of the front surface 2a of the casing 2. The sensor 10 serves to detect the variation of electrostatic capacitance and has a substrate 11, which is shown in FIG. 3. The substrate 11 is disposed over both the first operation region 6 and the second operation region 7. The substrate 11 is made of a dielectric material. For example, the substrate 11 is a hard plate formed of a resin film or a thin synthetic resin.

As shown in FIG. 3, in the sensor 10, an upper part of the substrate 11 in the longitudinal direction (Y direction) is a first region 12 and the other part located below the first region 12 is a second region 13. The sensor 10 can detect, as X-Y coordinate position on the substrate 11, the variation of electrostatic capacitance at a portion operated when a finger serving as a conductor approaches a surface of the sensor 10. Therefore, the sensor 10 is not divided into the first region 12 and the second region 13 in terms of a structure, but recognizes that the first region 12 has been operated if coordinate data corresponding to an operated portion is detected to be predetermined position data within the first region 12 and recognizes that the second region 13 has been operated if coordinate data corresponding to an operated portion is detected to be predetermined position data within the second region 13 by means of a data processing unit to be described later.

X electrodes X1, X2, X3, X4, and X5 are formed on one surface of the substrate 11. These X electrodes extend in a straight line manner in the longitudinal direction (Y direction) and are parallel to one another. Pitch and distance between the X electrodes in a lateral direction (X direction) are constant. On the one surface of the substrate 11, detection electrodes S1, S2, S3, S4, S5, and S6 which are common electrodes are provided. The detection electrodes extend in a straight line manner in the longitudinal direction (Y direction) so as to be parallel to one another, all of the X electrodes and the detection electrodes are positioned to be parallel to one another, and pitches and distances between the X electrodes and the detection electrodes in the lateral direction (X direction) are constant.

On the other surface of the substrate 11, Y electrodes Y1, Y2, Y3, Y4, Y5, Y6, Y7, Y8, and Y9 are provided. These Y electrodes extend in a straight line manner in the lateral direction (X direction) so as to be parallel to one another. In addition, pitch and distance between the Y electrodes in a longitudinal direction (Y direction) are constant over the first region 12 and the second region 13.

The respective X electrodes X1 to X5 are connected to an X driver 15, and the respective Y electrodes Y1 to Y9 are connected to a Y driver 16. In addition, the respective detection electrodes S1 to S6 makes a common line to be connected to a detection unit 17. The X driver 15, the Y driver 16, and the detection unit 17 is included in a sensor control unit 20 that is formed as an IC.

In the sensor 10, the X driver 15 causes a voltage to be applied to the X electrodes X1, X2, X3, X4, and X5 in the order and in a time division manner, and thus electric charges are supplied to the X electrodes X1, X2, X3, X4, and X5 in the order. In addition, the Y driver 16 causes a voltage to be applied to the Y electrodes Y1, Y2, Y3, Y4, Y5, Y6, Y7, Y8, and Y9 in the order and in a time division manner.

When a finger serving as a conductor touches the front surface 2a of the casing 2 located above the substrate 11 of the sensor 10, electrostatic capacitance between corresponding X electrode and the finger and electrostatic capacitance between the finger and corresponding detection occur in addition to electrostatic capacitance between the X electrode and the detection electrode at an operated portion touched with the finger and the periphery of the operated portion. As a result, the electrostatic capacitance between the X electrode and the detection electrode is reduced. Thus, it is possible to detect the position of X coordinate of the operated portion at which the electrostatic capacitance has been reduced on the basis of timing, at which the voltage is applied to one of the X electrodes X1 to X5, and a detection output applied from the detection electrode to the detection unit 17. The same is true for the relationship between the Y electrodes and the detection electrodes. That is, it is possible to detect the position of Y coordinate of the operated portion at which the electrostatic capacitance has been reduced on the basis of timing, at which a voltage is applied to one of the Y electrodes Y1 to Y5, and a detection output applied from the detection electrode to the detection unit 17.

The detection position of an X-Y coordinate is detected on the basis of, for example, 128-position resolution between adjacent X electrodes or 128-position resolution between adjacent Y electrodes.

As shown in FIG. 4, in the electronic apparatus 1, a detection signal of the operated portion on the X-Y coordinate, which is detected by the detection unit 17 within the sensor control unit 20, is applied to a data processing unit 21. In the data processing unit 21, the position on the X-Y coordinate with respect to the operated portion on the substrate 11 is calculated on the basis of the detection signal and it is determined that whether the first region 12 has been operation or the second region 13 has been operation on the basis of the detected coordinate. Then, if it is determined that the first region 12 has been operated, a relative coordinate output is calculated and generated on the basis of the detection signal from the sensor control unit 20. In addition, if it is determined that the second region 13 has been operated, an absolute coordinate output is calculated and generated on the basis of the detection signal from the sensor control unit 20.

The relative coordinate output and the absolute coordinate output generated by the data processing unit 21 are applied to a central control processing unit (CPU) 22. The central control processing unit 22 performs predetermined data processing on the basis of the relative coordinate output and the absolute coordinate output applied from the data processing unit 21, controls a display panel driver 23, and controls a display pattern.

In the present embodiment, the sensor 10 having the substrate 11, the sensor control unit 20, and the data processing unit 21 forms the input device.

FIG. 5 illustrates a control flow in the data processing unit 21. In FIG. 5 a prefix ‘S’ represents a ‘step’.

In the data processing unit 21, in step S1, it is determined whether or not the sensor 10 has detected an operated portion. Then, if it is determined that the sensor 10 has detected an operated portion, it is determined whether the operated portion on the X-Y coordinate exists in the first region 12 or the second region 13 in step S2. If it is determined that the operated portion exists in the first region 12, it is determined whether or not the operated portion has moved in step S3. If it is determined that the operated portion has moved, a relative coordinate output is generated by calculating whether the movement direction of the operated portion is toward a plus side (for example, a right side) of the X direction or a minus side (for example, a left side) thereof and whether the movement direction is toward a plus side (for example, an upper side) of the Y direction or a minus side (for example, a lower side) thereof in step S4. Then, in step S5, the relative coordinate output is applied to the central control processing unit 22.

If it is determined that the operated portion is the second region 13 in step S2, in step S6, the position of the operated portion on the X-Y coordinate is calculated on the basis of the detection signal applied from the sensor control unit 20 and if the operated portion has moved, an absolute coordinate output is obtained by calculating the position of the moved portion on the X-Y coordinate. Then, in step S7, the absolute coordinate output is applied to the central control processing unit 22.

The ‘relative coordinate output’ generated by the data processing unit 21 refers to a signal indicating that a finger moves in the X direction when the finger touches the first operation region 6 of the electronic apparatus 1 shown in FIG. 1 so that the electrostatic capacitance between electrodes in the first region 12 of the substrate 11 shown in FIG. 3 varies and when the operated portion at which the electrostatic capacitance has varied moves, a signal indicating whether the movement direction is toward the plus side (for example, the right side) or the minus side (for example, the left side), a signal indicating that the finger moves in the Y direction, and a signal indicating whether the movement direction is toward the plus side (for example, the upper side) or the minus side (for example, the lower side). For example, the ‘relative coordinate output’ has a 3-byte configuration. The central control processing unit 22 detects the relative coordinate output at detection timing under a condition of constant intervals. If the signal indicating the operated portion moves in the X direction or Y direction can be obtained at each detection timing, the central control processing unit 22 performs an adding operation by accumulating the movement distance every predetermined value and recognizes the movement amount of the operated portion in the X direction and the movement amount of the operated portion in the Y direction.

Alternatively, in step S4 shown in FIG. 5, when a signal indicating that the operated portion has moved in the X direction and a signal indicating that the operated portion has moved in the Y direction still exist, the data processing unit 21 may calculate the movement distance by an adding process of accumulating predetermined values and apply the relative coordinate output, which includes the signal indicating the movement distance in the X direction and the signal indicating the movement distance in the Y direction, to the central control processing unit 22.

The ‘absolute coordinate output’ generated in the data processing unit 21 can be obtained by calculating the position of an operated portion on the X-Y coordinate on the basis of a detection signal applied from the sensor control unit 20, when a finger touches the second operation region 7 of the electronic apparatus 1 and thus the electrostatic capacitance between electrodes changes in the second region 13 of the sensor 10. The ‘absolute coordinate output’ includes position data of the operated portion on an X coordinate and position data of the operated portion on a Y coordinate. For example, the ‘absolute coordinate output’ is 4-byte or more data. The position data of the operated portion is applied from the data processing unit 21 to the central control processing unit 22 at constant intervals. Then, in the central control processing unit 22, movement traces of the operated portion are calculated on the basis of the position data that is intermittently supplied.

Alternatively, the data processing unit 21 may create data including the position of the operated portion and the movement amount varying each time and then the data may be applied as the ‘absolute coordinate output’ to the central control processing unit 22.

As shown in FIG. 1, on the front surface 2a of the casing 2, an area display 31 indicating an input region of a relative coordinate is provided on the first operation region 6. The area display 31 may be attached on the front surface 2a of the casing 2 by means of, for example, a printing method, or the front surface 2a of the casing 2 may protrude above a lip in the edge of the area display 31. Alternatively, the area display 31 may be formed by laminating a resin film, of which coefficient of friction is low, on the front surface 2a of the casing 2. In addition, an operation guide display 32, which serves as a guide with respect to the direction in which a finger slides, may be provided within the area display 31.

A plurality of key marks 33 are provided in the second operation region 7 of the front surface 2a of the casing 2. The key marks 33 are formed on the front surface 2a of the casing 2 by means of a printing method, for example. Alternatively, thin press buttons may be provided instead of the key marks 33, such that thin switches can operate by means of the press buttons.

FIGS. 6 and 7 views illustrating examples of an operation of the electronic apparatus 1 and processing and details of display in the display region 3 at the time of the operation.

FIG. 6 illustrates a state where the electronic apparatus 1 is set as a menu input mode. The menu input mode is set by touching the key mark 33 with a finger, for example. If the menu input mode is set, a menu screen 41 is displayed in the display region 3 by a display operation of the display panel 5. The menu screen 41 is partitioned and displayed such that a plurality of kinds of operation menus are horizontally and vertically arranged, and a pointer serving to select a menu is displayed on the menu screen 41.

On the menu screen 41 immediately after the menu input mode has started, the pointer 42 is positioned within a central section of the menu screen 41. If a finger 50 touches the area display 31 of the first operation region 6 and slides along the operation guide display 32, information on movement of an operated portion of the finger 50 is supplied as a relative coordinate output from the data processing unit 21 to the central control processing unit 22. The central control processing unit 22 acquires information on the movement direction and movement distance of the operated portion based on the relative coordinate output and controls the display panel driver 23 on the basis of the acquired information. As a result, in the display region 3, the pointer 42 moves to a selected section of the menu screen 41 in accordance with the sliding movement direction and distance of the finger 50. If the finger 50 is apart from the area display 31, the pointer 42 moves to the selected section of the menu screen 41 and stops.

Then, by touching one of the key marks 33 with the finger 50 or tapping (performing an operation of touching a part of the area display 31 with the finger 50 and then detaching the finger 50 at high speed) the part of the area display 31 with the finger 50, software corresponding to a menu displayed on the selected section starts.

In addition, when the menu input mode is set, the setting may be made such that sensing in the first operation region 6, sensing that the finger 50 touches the area display 31 and slides, and sensing a tapping operation are possible. At this time, it is possible to make a setting such that the data processing unit 21 disregards detection of an operated portion in the second operation region 7. This may be performed by making only variation of electrostatic capacitance between electrodes in the first region 12 of the sensor 10 effective and disregarding variation of electrostatic capacitance between electrodes in the second region 13. With the configuration described above, even if a finger or a palm touches the second operation region 7 during an operation mode of operating the first operation region 6, the electronic apparatus 1 does not malfunction.

Moreover, in the menu input mode or the like, instead of displaying the pointer 42 in the display region 3, each section of the menu screen 41 may be highlight-displayed according to the movement direction and movement distance of the operated portion when the relative coordinate output is generated as a result of touching the first operation region 6 with the finger 50.

FIG. 7 illustrates a state in which the electronic apparatus 1 is set in a text input mode. The text input mode is set by touching one of the key marks 33 with a finger, for example. If the text input mode is set, a text input screen 45 is displayed on the display region 3. When the finger 50 touches the second operation region 7 of the front surface 2a of the casing 2, a corresponding operated portion is applied to the central control processing unit 22 as an absolute coordinate output including the position data on the X-Y coordinate. Therefore, in the second operation region 7, if the finger 50 slides in the horizontal direction as shown by arrow Xa, a line 46x extending in the horizontal direction is shown on display region 3. Thereafter, when the finger 50 is detached from the second operation region 7, moves upward so as to again touch the second operation region 7, and then slides downward as shown by arrow Ya, a line 46y extending in the vertical direction is shown on display region 3.

By performing the operation described above, characters can be written on the display region 3. After writing the characters, the character input is confirmed by touching any one of the key marks 33 with the finger 50 or tapping the second operation region 7 with the finger 50. Furthermore, in the central control processing unit 22 of the electronic apparatus 1, the input characters are recognized on the basis of the absolute coordinate output applied from the data processing unit 21. At this time, it may be possible to cause the character input to be completed by inputting only the radical with an operation of the finger 50 and then the central control processing unit 22 to extract characters having the input radical and to display the extracted characters on the display screen. At this time, a plurality of characters is arranged and displayed on the display region 3, in the same manner as in the menu display mode shown in FIG. 6. Then, an operation input in the first operation region 6 becomes effective, and accordingly, one of the plurality of characters can be selected by sliding the finger 50, which touches the area display 31, in any direction. After selecting one of the plurality of characters, the selected character can be confirmed by touching any one of the key marks 33 with the finger 50 or tapping the area display 31 with the finger 50.

In addition, when performing a character input or the like by operating the second operation region 7 with the finger 50, it is preferable to make only a detection operation in the second operation region 7 effective and to disregard a sense signal, which is obtained from the sensor 10, of the finger 50 in the first operation region 6. With the configuration described above, even if a finger touches the first operation region 6 while inputting a character, it is possible to prevent an adverse effect on the character input.

In addition, in the case when it is necessary to perform a press operation on the key marks 33 for the purpose of typical number input or menu selection confirmation, the setting is made such that detection of an operated portion is effective in only a part of the second operation region 7 attached with the key marks 33 and the data processing unit 21 or the central control processing unit 22 disregards a sense signal when the finger 50 touches a portion deviating from the key marks 33 and thus corresponding sense signal is obtained from the sensor 10. Thus, it is possible to detect, on the basis of the absolute coordinate output, that the finger 50 touches one of the plurality of key marks 33, and a number input operation or the like can be performed according to the display of the key marks 33.

Further, in the sensor 10 according to the embodiment described above, the X electrodes, the Y electrodes, and the detection electrodes are provided on the substrate 11, the voltage is applied to the X electrodes and the Y electrodes in the order, and the variation of the electrostatic capacitance is detected on the basis of the output of the detection electrode. However, any sensor may be used as a sensor forming the input device according to the embodiment of the invention, as long as the sensor has a configuration capable of detecting the electrostatic capacitance. For example, it is possible to use a sensor in which X electrodes, Y electrodes, and ground electrodes are provided and variation of electrostatic capacitance between the X electrodes and the ground electrodes and variation of electrostatic capacitance between the Y electrodes and the ground electrodes.

In addition, it may be possible to use a configuration in which the input device according to the embodiment of the invention is disposed on an operation side of a personal computer, a relative coordinate output such as an operation of a mouse is applied to an operation system (OS) by an operation on the first region 12, and an absolute coordinate output is applied to the OS by an operation on the second region 13. In addition, the area or position of a sensing section of the first region 12 or the second region 13 may be arbitrarily set under a state in which the data processing unit 21 can be set by an external operation.

It is intended that the foregoing detailed description be understood as an illustration of selected forms that the invention can take and not as a definition of the invention. It is only the following claims, including all equivalents, that are intended to define the scope of this invention.

1. An input device that detects variation of electrostatic capacitance between a plurality of electrodes extending in the X and Y directions of a substrate caused by an input mechanism comprising:
a substrate divided into at least a first region and a second region;
a data processing unit that, in the first region, when it is sensed that an operated portion at which electrostatic capacitance has varied moves, generates a relative coordinate output signal based on a detection signal with respect to the movement of the operated portion and in the second region, when the operated portion is detected or it is sensed that the operated portion moves, generates an absolute coordinate output signal based on a detection signal with respect to the operated portion.

2. The apparatus of claim 1 wherein the relative coordinate output comprises a movement signal to indicate the movement and a direction of the input mechanism, and the absolute coordinate output comprises a position signal to indicate a position of the input mechanism.

3. The apparatus of claim 2 wherein the movement signal further indicates a distance.

4. An electronic apparatus comprising:
an input device including:
a substrate divided into at least a first region and a second region;
a data processing unit that, in the first region, when it is sensed that an operated portion at which electrostatic capacitance has varied moves, generates a relative coordinate output signal based on a detection signal with respect to the movement of the operated portion and in the second region, when the operated portion is detected or it is sensed that the operated portion moves, generates an absolute coordinate output signal based on a detection signal with respect to the operated portion
a display panel; and
a central control processing unit that controls details of display of the display panel by processing a relative coordinate output and an absolute coordinate output applied from the input device.

5. The electronic apparatus according to claim 4,
wherein, when the relative coordinate output is applied to the central control processing unit, an instruction mark displayed on a screen of the display panel moves toward a movement direction of the operated portion with any position on the screen as a reference.

6. The electronic apparatus according to claim 4,
wherein, when the absolute coordinate output is applied to the central control processing unit, a display on the screen of the display panel moves on X-Y coordinate on the screen in corresponds to a coordinate to which the operated portion has moved.

7. The electronic apparatus according to claim 4,
wherein, when the absolute coordinate output is applied to the central control processing unit, the central control processing unit recognizes the absolute coordinate output as a switch input corresponds to the position of the operated portion on the X-Y coordinate.
